(19) United States
(12) Patent Application Publication
(10) Pub. No.: US 2026/0219136 A1
(43) Pub. Date: Jul. 30, 2026

(54) FAULT MONITORING METHOD AND FAULT MONITORING SYSTEM

(71) Applicant: Schaeffler Technologies AG & Co. KG, Herzogenaurach (DE)

(72) Inventors: Zhi Qiu, Shanghai (CN); Hualiang Hu, Shanghai (CN); Zhihui Pan, Shanghai (CN); Qiang Guo, Shanghai (CN)

(73) Assignee: Schaeffler Technologies AG & Co. KG, Herzogenaurach (DE)

(21) Appl. No.: 19/147,321

(22) PCT Filed: Jan. 12, 2023
(86) PCT No.: PCT/CN2023/071896

§ 371 Date: Jul. 11, 2025

(51) Int. Cl. G01M 17/007; G01H 3/06; G01H 3/08; G01H 3/12

(52) U.S. Cl. CPC G01M 17/007; G01H 3/06; G01H 3/08; G01H 3/12

(57) ABSTRACT

A planetary gearbox includes a housing having a pair of stops, a planet bearing mounted in the housing, and a planet gear rotatable on the planet bearing. The planet bearing is formed from an axially aligned planet pin and a thrust washer. The thrust washer includes two integrally-formed projections, each facing one of the stops to prevent rotation of the thrust washer about the planetary axis. The thrust washer also includes first thrust surfaces disposed on a first side of the thrust washer facing the housing, first lubrication channels formed axially opposite the first thrust surfaces and extending radially outwards, second thrust surfaces circumferentially offset from the first thrust surfaces and disposed on a second side of the thrust washer facing the planet gear, and second lubrication channels formed axially opposite the second thrust surfaces and extending radially outwards.

### CROSS REFERENCE TO RELATED APPLICATIONS

This application is a U.S. National Stage Application of Patent Cooperation Treaty (PCT) Application No. PCT/CN2023/071896 filed Jan. 12, 2023, the content of which is incorporated by reference herein in its entirety.

### TECHNICAL FIELD

The present invention relates to the technical field of vehicles. Specifically, the present invention relates to a fault monitoring method and a fault monitoring system for a motor vehicle.

### BACKGROUND

In a motor vehicle, in-service states of various components (for example, an engine, a transmission, various axles, and a hub, etc.) of a power system arranged in a chassis of a vehicle have a vital impact on the operating safety of the vehicle. Many important components in the power system are rotating components. In the prior art, the monitoring of these rotating components is usually based on vibration and rotational speed signals and is performed by applying resonance demodulation and frequency spectrum analysis. Currently, for the fault monitoring of the rotating components, the conventional resonance demodulation method has been proven to be one of the most effective means.

However, in the actual vehicle state (for example, an operating state of a truck) monitoring, it is difficult to implement the above traditional monitoring method because some chassis components (for example, a middle axle, a rear axle, the hub, etc.) lack sufficient space for the mounting of a rotational speed sensor. In addition, during the driving process of the vehicle, a bumpy road surface also generates a large amount of interference that is difficult to remove to vibration signals collected by a vibration sensor, which brings great difficulties to the implementation of the traditional signal analysis method. Meanwhile, the traditional analysis method is also difficult to effectively diagnose abnormal sounds or abnormal vibrations generated by some structural members of non-rotating components.

### SUMMARY

Therefore, a technical problem to be solved by the present disclosure is to provide an improved fault monitoring method and fault monitoring system.

The above technical problem is solved by a fault monitoring method for monitoring an operating state of a power system of a motor vehicle according to the present disclosure. The fault monitoring method includes:
collecting in real time a sound signal in a cab of the motor vehicle and one or more vibration signals that correspond to one or more monitoring positions in the power system, respectively;
calculating a frequency response function between the sound signal and each vibration signal and obtaining a peak point frequency corresponding to a peak point of each frequency response function;
calculating a coherence feature function between each vibration signal and the sound signal and obtaining an amplitude corresponding to the peak point frequency of each frequency response function;
judging whether the amplitude corresponding to the peak point frequency of each frequency response function is greater than a predetermined threshold value; and
when the amplitudes corresponding to the peak point frequencies of one or more frequency response functions are each greater than the predetermined threshold value, determining that a fault occurs at the monitoring positions where the vibration signals corresponding to the one or more frequency response functions are collected.

This fault monitoring method analyzes the operating state at the monitoring position through a relationship between the sound signal in the cab and the vibration signal of the monitoring position in the power system. Since the sound signal collected in the cab is less affected by interference from an external environment, especially a road surface, the accuracy of fault judgment may be improved, thereby monitoring the operating state of the power system timely and effectively. Meanwhile, a vibration sensor requires small mounting space, so that a mounting position is more flexible.

According to one embodiment of the present disclosure, calculating a frequency response function between the sound signal and each vibration signal includes:
calculating a cross-power density spectrum of each vibration signal and the sound signal, an auto-power density spectrum of the sound signal, and an auto-power density spectrum of each vibration signal;
calculating the frequency response function between the sound signal and each vibration signal based on the cross-power density spectrum of each vibration signal and the sound signal, the auto-power density spectrum of the sound signal, and the auto-power density spectrum of each vibration signal; and
obtaining a frequency response function matrix based on the frequency response function between the sound signal and each vibration signal.

According to another embodiment of the present disclosure, the one or more monitoring positions in the power system may include one or more of the following: a transmission housing, housings of one or more axles, and/or hubs corresponding to the one or more axles. These components are all key components of the power system, and operating states of these components are of great significance for safety of the vehicle. Meanwhile, these components are generally located in a chassis of the vehicle, and signals detected at these components are easily affected by interference from a bumpy road surface. The operating states of these components may be monitored in real time and reliably by the fault monitoring method of the present disclosure.

According to another embodiment of the present disclosure, a position where the sound signal is collected may be located in a peripheral area of a head of a driver in the cab. An auditory sense of the driver may be effectively simulated at this collection position, so that the operating state of the power system may be monitored in a manner similar to auditory judgment of the driver.

According to another embodiment of the present disclosure, the predetermined threshold value may be 0.5. The closer the amplitude corresponding to the peak point frequency is to 1, the higher the possibility of the fault occurring at the corresponding monitoring position. However, in actual applications, due to impacts of various factors, the amplitude often cannot actually reach 1 when the fault occurs. Therefore, according to experience, setting the predetermined threshold value to 0.5 may allow the fault to be identified more reliably.

According to another embodiment of the present disclosure, the one or more vibration signals may be vibration acceleration signals. The vibration signal may usually be represented by three parameters: a vibration speed, a vibration acceleration, and a vibration position, wherein the vibration acceleration often contains more information, so that the operating state of the power system can be better reflected.

According to another embodiment of the present disclosure, the fault monitoring method also includes: when it is determined that the fault occurs at at least one monitoring position, sending information about the at least one monitoring position where the fault occurs to an end user and/or a control system of the motor vehicle. The end user may include the driver of the vehicle, a remote controller of the vehicle, an operator of a vehicle management platform, and/or other personnel who need to pay attention to an operating state of the vehicle.

The above technical problem is also solved by a fault monitoring system for monitoring an operating state of a power system of a motor vehicle according to the present disclosure. The fault monitoring system includes a signal collection subsystem and a data processing subsystem, wherein
the signal collection subsystem includes:
a sound sensor arranged in a cab of the motor vehicle to collect in real time a sound signal in the cab; and
one or more vibration sensors arranged at one or more monitoring positions in the power system, respectively, to collect in real time corresponding one or more vibration signals; and
the data processing subsystem includes:
a first calculation module configured to calculate a frequency response function between the sound signal and each vibration signal and obtain a peak point frequency corresponding to a peak point of each frequency response function;
a second calculation module configured to calculate a coherence feature function between each vibration signal and the sound signal and obtain an amplitude corresponding to the peak point frequency of each frequency response function;
a judgment module configured to judge whether the amplitude corresponding to the peak point frequency of each frequency response function is greater than a predetermined threshold value; and
a determining module configured to: when the amplitudes corresponding to the peak point frequencies of one or more frequency response functions are each greater than the predetermined threshold value, determine that a fault occurs at the monitoring positions where the vibration signals corresponding to the one or more frequency response functions are collected.

An operating state at the monitoring position is analyzed by the fault monitoring system through a relationship between the sound signal in the cab and the vibration signal of the monitoring position in the power system. Since the sound signal collected in the cab is less affected by interference from an external environment, especially a road surface, the accuracy of fault judgment may be improved, thereby monitoring the operating state of the power system timely and effectively. Meanwhile, a vibration sensor requires small mounting space, so that a mounting position is more flexible.

According to one embodiment of the present disclosure, the first calculation module is further configured to:
calculate a cross-power density spectrum of each vibration signal and the sound signal, an auto-power density spectrum of the sound signal, and an auto-power density spectrum of each vibration signal;
calculate the frequency response function between the sound signal and each vibration signal based on the cross-power density spectrum of each vibration signal and the sound signal, the auto-power density spectrum of the sound signal, and the auto-power density spectrum of each vibration signal; and
obtain a frequency response function matrix based on the frequency response function between the sound signal and each vibration signal.

According to another embodiment of the present disclosure, the one or more vibration sensors may be arranged at one or more of the following monitoring positions, respectively: a transmission housing, housings of one or more axles, and/or hubs corresponding to the one or more axles. These components are all key components of the power system, and operating states of these components are of great significance for safety of the vehicle. Meanwhile, these components are generally located in a chassis of the vehicle, and signals detected at these components are easily affected by interference from a bumpy road surface. The operating states of these components may be monitored in real time and reliably by the fault monitoring system of the present disclosure.

According to another embodiment of the present disclosure, the sound sensor may be arranged in a peripheral area of a head of a driver in the cab. This mounting position may allow the sensor to effectively simulate an auditory sense of the driver, so that the operating state of the power system may be monitored in a manner similar to auditory judgment of the driver.

According to another embodiment of the present disclosure, the judgment module may be configured to use 0.5 as the predetermined threshold value. The closer the amplitude corresponding to the peak point frequency is to 1, the higher the possibility of the fault occurring at the corresponding monitoring position. However, in actual applications, due to impacts of various factors, the amplitude often cannot actually reach 1 when the fault occurs. Therefore, according to experience, setting the predetermined threshold value to 0.5 may allow the fault to be identified more reliably.

According to another embodiment of the present disclosure, the one or more vibration sensors may be configured to collect vibration acceleration signals. The vibration signal may usually be represented by three parameters: a vibration speed, a vibration acceleration, and a vibration position, wherein the vibration acceleration often contains more information, so that the operating state of the power system can be better reflected.

According to another embodiment of the present disclosure, the data processing subsystem may also include an information sending module, and the information sending module is configured to: when it is determined that the fault occurs at at least one monitoring position, send information about the at least one monitoring position where the fault occurs to an end user and/or a control system of the motor vehicle. The end user may include the driver of the vehicle, a remote controller of the vehicle, an operator of a vehicle management platform, and/or other personnel who need to pay attention to an operating state of the vehicle.

### BRIEF DESCRIPTION OF THE DRAWINGS

The present disclosure is further described below in conjunction with the accompanying drawings. The same reference numerals in the drawings will be used to represent elements with the same functions. In the drawings:

FIG. 1 shows a flowchart of a fault monitoring method according to an exemplary embodiment of the present disclosure; and

FIG. 2 shows a schematic diagram of a fault monitoring system according to an exemplary embodiment of the present disclosure.

### DETAILED DESCRIPTION

Specific implementations of a fault monitoring method and a fault monitoring system according to the present disclosure will be described below in conjunction with the accompanying drawings. The following detailed description and accompanying drawings are used for exemplary illustrations of the principle of the present disclosure. The present disclosure is not limited to the described embodiments, and the scope of protection of the present disclosure is defined by the claims.

According to the embodiments of the present disclosure, a fault monitoring method and a fault monitoring system for monitoring an operating state of a power system of a motor vehicle are provided. This fault monitoring method and system may perform fault monitoring on components of the power system through a sound signal from an inside of a cab and vibration signals from the power system.

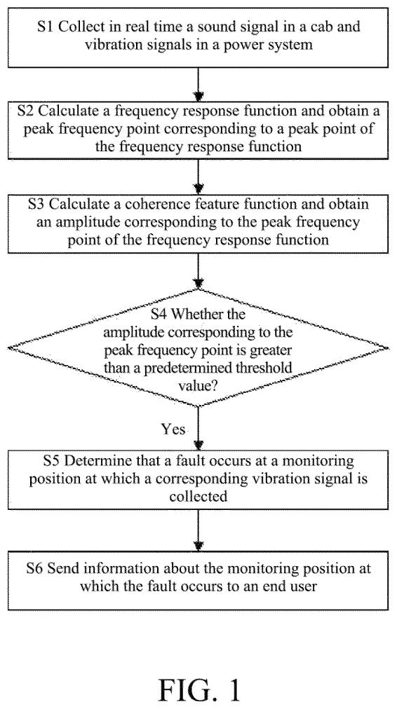

FIG. 1 shows a flowchart of a fault monitoring method according to an exemplary embodiment of the present disclosure. As shown in FIG. 1, the fault monitoring method mainly includes the following steps: step S1: signal collection; step S2: peak point frequency calculation; step S3: peak point frequency amplitude calculation; step S4: amplitude comparison and judgment; and step S5: fault determination. Various steps of the fault monitoring method will be described in detail below in conjunction with FIG. 1.

First, in step S1, a sound signal in a cab of a motor vehicle and one or more vibration signals of one or more monitoring positions in a power system are collected in real time, respectively.

The sound signal here may be collected by various known sound sensors. The sound sensors are mounted at predetermined positions in the cab of the motor vehicle, so that the sound signal in the cab may be collected. The sound signal in the cab contains sound information from a chassis of the vehicle, and this sound information is less affected by interference from an external environment of the vehicle, especially interference from a bumpy road surface. A position where the sound signal is collected may be located near a head of a driver in the cab, so that a sound effect heard by the driver in the cab may be simulated. Certainly, the position where the sound signal is collected may also be located in other parts in the cab, as long as it is conducive to reducing external interference.

The one or more vibration signals collected correspond to the one or more monitoring positions selected, respectively. That is, one corresponding vibration signal is obtained at each monitoring position. These monitoring positions may be selected according to practical experience or specific needs. Usually, the selected monitoring positions are key components and/or components prone to the occurrence of faults in the power system, for example, a transmission housing, housings of one or more axles, and/or hubs corresponding to the axles. The collected vibration signals may be vibration speed signals, vibration acceleration signals, and/or vibration position signals. Since the vibration acceleration signals contain more information and can usually better reflect a true state of vibration, the vibration acceleration signals may be collected.

After the above sound signal and vibration signals are collected, these pieces of signal information will be sent to a relevant processing apparatus for subsequent steps. A manner of sending the information may be a wired or wireless manner, which is not limited by the present disclosure.

After various required signals are obtained in step S1, execution of step S2 may be started. In step S2, a frequency response function between the sound signal and each vibration signal that are obtained in step S1 is calculated, and a peak point frequency corresponding to a peak point of each frequency response function is obtained. A specific calculation process is as follows.

First, a cross-power density spectrum Sₓ_{ᵢ}_{y}_{ⱼ} (f) of each collected vibration signal and the sound signal in the cab, an auto-power density spectrum S_{y}_{ⱼ}_{y}_{ⱼ}(f) of the sound signal, and an auto-power density spectrum Sₓ_{ᵢ}ₓ_{ᵢ}(f) of each vibration signal are calculated in sequence. In the formula, xᵢ represents a vibration signal collected at an i^{th} monitoring position (a position of a vibration sensor), and yⱼ represents a j^{th} sound signal collected. Since only one sound signal needs to be collected, j=1. A value of i depends on a number n of the selected monitoring positions, that is, the numerical value of i is each integer from 1 to n, respectively. For example, if 7 monitoring positions are selected, i=1, 2, . . . , 7. Thus, a cross-power density spectrum matrix Sₓ_{ᵢ}_{y}_{ⱼ}=[Sₓ_{₁}_{y}_{₁},Sₓ_{₂}_{y}_{₁},Sₓ_{₃}_{y}_{₁} . . . Sₓ_{ₙ}_{y}_{₁}] and an auto-power density spectrum S_{y}_{₁}_{y}_{₁}, of various signals may be obtained. After the auto-power density spectrum and the cross-power density spectrum of various signals are obtained, the frequency response function (FRF) may be calculated, with a calculation formula of the frequency response function as follows:

$${H}_{ij} ( f ) = \frac{{S}_{{y}_{j} {y}_{j}} ( f )}{{S}_{{y}_{j} {x}_{i}} ( f )}$$

In the formula, Hᵢⱼ (f) represents a frequency response function between the vibration signal collected at the i^{th} monitoring position and the j^{th} sound signal. Value rules of i and j are as described above.

The above method for calculating the auto-power density spectrum and the cross-power density spectrum of various signals and thus calculating the frequency response function is well known in the art, which will not be described in detail again here.

For each collected vibration signal, one corresponding frequency response function may be obtained. After the frequency response functions between the sound signal and various vibration signals are calculated in sequence, a frequency response function matrix based on various signals may be obtained. Regardless of what type of vibration signal (a vibration speed, a vibration acceleration, or a vibration position) is used as an input of the frequency response function in this method, a frequency response relationship between the vibration of the monitoring position and the sound signal in the cab may be reflected. That is, when a fault occurs on a component of a certain monitoring position, there will be a certain frequency correspondence relationship between a vibration signal of the monitoring position and the sound signal in the cab. That is, on the frequency response function, an amplitude corresponding to a correlation frequency (usually a natural frequency) increases, and vice versa. Through a peak search algorithm, various peak points of each frequency response function and frequencies (referred to as peak point frequencies) corresponding to these peak points may be found. These peak point frequencies will be used for calculating the amplitudes in a next step.

After the peak point frequencies of each frequency response function are obtained, step S3 may be executed. In step S3, a coherence feature function between each vibration signal and the sound signal is calculated, and the amplitudes corresponding to the peak point frequencies of each frequency response function are obtained based on the coherence feature function. A specific calculation process is as follows.

A calculation formula of the coherence feature function is as follows:

$${γ}_{ij} = \sqrt{\frac{{S}_{{x}_{i} {y}_{j}}}{{S}_{{x}_{i} {x}_{j}} \cdot {S}_{{y}_{j} {y}_{j}}}}$$

In the formula, γᵢⱼ represents a coherence feature function between the vibration signal collected at the i^{th} vibration monitoring position and the j^{th} sound signal. Value rules of i and j are as described above. Thus, a coherence feature function matrix γᵢⱼ=[γ₁₁, γ₂₁, γ₃₁ . . . γₙ₁] may be obtained. The coherence feature function reflects a frequency linear relationship between the sound signal and the vibration signals. A calculation method of the coherence feature function is also well known in the art, which will not be described in detail again here.

By substituting the peak point frequency obtained in step S2 into a corresponding coherence feature function, an amplitude corresponding to a peak point frequency of each coherence feature function may be calculated. That is, a peak amplitude corresponding to each peak point frequency is calculated through the coherence feature function. Judgment in the next step may be performed based on the peak amplitude.

Next, in step S4, whether the amplitude corresponding to the peak point frequency of each frequency response function is greater than a predetermined threshold value is judged. When a fault occurs, if a peak amplitude of a certain coherence feature function is close to 1, it indicates that a vibration monitoring position corresponding to the coherence feature function is a fault sound source, that is, the fault occurs at the monitoring position. If the peak amplitude of the coherence feature function between the sound signal and a certain vibration signal is close to 0, it indicates that a corresponding vibration monitoring position does not contribute to the fault sound source, that is, the fault does not occur at the monitoring position. The closer the amplitude corresponding to the peak point frequency is to 1, the higher the possibility of the fault occurring at the corresponding monitoring position. However, in actual applications, due to impacts of various factors, the amplitude often cannot actually reach 1 when the fault occurs. Therefore, according to experience, the predetermined threshold value may be set to 0.5, to facilitate the reliable identification of the fault.

Based on the above principle, after a comparison result of step S4 is obtained, step S5 may be executed according to the comparison result. In step S5, when the amplitudes corresponding to the peak point frequencies of one or more frequency response functions are each greater than the predetermined threshold value, it is determined that the fault occurs at the monitoring positions where the vibration signals corresponding to the one or more frequency response functions are collected. Specifically, if there are one or more amplitudes each greater than the predetermined threshold value in a vector of the coherence feature function matrix, a path index value of the coherence feature function matrix, that is, a transfer path of the fault sound source, is returned, so that the vibration monitoring position corresponding to the fault can be determined.

In addition, the fault monitoring method may further include an additional step S6 of fault reporting. In step S6, based on a determination result of step S5, when it is determined that the fault occurs at at least one monitoring position, information about the at least one monitoring position where the fault occurs (that is, a position where the fault occurs) is sent to an end user and/or a control system of the motor vehicle. The end user may include the driver of the vehicle, a remote controller of the vehicle, an operator of a vehicle management platform, and/or other personnel who need to pay attention to an operating state of the vehicle. The control system may include various systems for controlling an operation of the vehicle, for example, a vehicle control unit, etc. The information about the determined fault monitoring position may include, but is not limited to: a name of a component where the monitoring position is located, a current operating parameter of the component, and/or product information of the component, etc. A manner of sending relevant information may be various known information transfer manners, for example, various wired transmitting or wireless transmitting manners, such as Bluetooth, Internet, a local area network, or a 4G/5G wireless communication network, etc.

In the above fault monitoring method, processes of steps S1 to S6 are performed in real time. In step S1, the signals are collected in real time (that is, collected once every small, predetermined time period), and the signals collected each time are processed according to the subsequent steps. Therefore, when the fault occurs in the power system, a faulty component may be found timely.

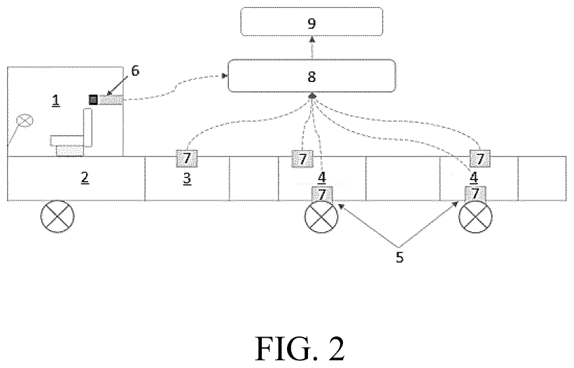

FIG. 2 shows a schematic diagram of a fault monitoring system according to an exemplary embodiment of the present disclosure. The fault monitoring system may implement the fault monitoring method according to the previous embodiments accordingly. The fault monitoring system mainly includes a signal collection subsystem and a data processing subsystem. Various components of the fault monitoring system will be described in detail below in conjunction with FIG. 2.

The signal collection subsystem may execute step S1 in the fault monitoring method according to the previous embodiments to collect various required signals. As shown in FIG. 2, the signal collection subsystem includes a sound sensor 6 and one or more vibration sensors 7. The sound sensor 6 is arranged in a cab 1 of a motor vehicle to collect in real time a sound signal in the cab 1. The sound sensor 6 here may be various known sound sensors. As mentioned above, the sound sensor 6 is mounted at a predetermined position in the cab 1 of the motor vehicle, for example, located near a head of a driver in the cab 1. The one or more vibration sensors 7 are arranged at one or more monitoring positions in a power system, respectively, to collect in real time corresponding one or more vibration signals. One corresponding vibration sensor 7 is arranged at each monitoring position, respectively, thereby obtaining one corresponding vibration signal. The power system is mainly located in a chassis 2 of the motor vehicle. As shown in FIG. 2, these vibration sensors 7 may be, for example, arranged at a housing of a transmission 3, housings of one or more axles 4, and/or hubs 5 corresponding to the axles 4, respectively. As mentioned above, the vibration signals collected by the vibration sensors 7 may be vibration speed signals, vibration acceleration signals, and/or vibration position signals.

After the above sound signal and vibration signals are collected, various sensors may send corresponding signal information to the data processing subsystem 8 in a wired or wireless manner for subsequent processing.

The data processing subsystem 8 may execute steps S2 to S5 (and possible additional step S6) in the fault monitoring method according to the previous embodiments to process the signals. The data processing subsystem 8 includes a first calculation module, a second calculation module, a judgment module, and a determining module, and may also optionally include an information sending module. Various modules of the data processing subsystem 8 may be integrated into a certain data processing apparatus, for example, may be implemented in a vehicle control unit of the motor vehicle.

The first calculation module may execute step S2 in the fault monitoring method according to the previous embodiments. That is, the first calculation module is configured to calculate a frequency response function between the sound signal and each vibration signal that are obtained by the signal collection subsystem and obtain a peak point frequency corresponding to a peak point of each frequency response function. A specific calculation process is as described in the previous method embodiments, which will not be described in detail again here.

The second calculation module may execute step S3 in the fault monitoring method according to the previous embodiments. That is, the second calculation module is configured to calculate a coherence feature function between each vibration signal and the sound signal and obtain an amplitude corresponding to the peak point frequency of each frequency response function. A specific calculation process is as described in the previous method embodiments, which will not be described in detail again here.

The judgment module may execute step S4 in the fault monitoring method according to the previous embodiments. That is, the judgment module is configured to judge whether the amplitude corresponding to the peak point frequency of each frequency response function is greater than a predetermined threshold value. A specific judgment process is as described in the previous method embodiments, which will not be described in detail again here. The judgment module may store the predetermined threshold value determined based on experience. The predetermined threshold value stored in the judgment module may be, for example, 0.5.

The determining module may execute step S5 in the fault monitoring method according to the previous embodiments. That is, the determining module is configured to: when the amplitudes corresponding to the peak point frequencies of one or more frequency response functions are each greater than the predetermined threshold value, determine that a fault occurs at the monitoring positions where the vibration signals corresponding to the one or more frequency response functions are collected. A specific determining process is as described in the previous method embodiments, which will not be described in detail again here.

The optional information sending module may execute step S6 in the fault monitoring method according to the previous embodiments. That is, the information sending module is configured to: when it is determined that the fault occurs at at least one monitoring position, send information about the at least one monitoring position where the fault occurs (a position where the fault occurs) to an end user and/or a control system 9 of the motor vehicle. A manner of sending relevant information by the information sending module may be various known information transfer manners, for example, various wired transmitting or wireless transmitting manners, such as Bluetooth, Internet, a local area network, or a 4G/5G wireless communication network, etc.

The fault monitoring method and system according to the present disclosure may implement fault positioning based on an acoustic-vibration coherence feature without a need to use a rotational speed measurement device, so that the mounting space and costs may be saved. Since the sound signal comes from the inside of the cab, the monitoring method and system are not easily affected by interference from noise outside the vehicle. The sound signal collected in the cab may replace a perception of the human ear on a fault sound to provide an information basis for fault judgment, which facilitates the implementation of automation of a monitoring process, thereby being suitable for an application scenario of an unmanned vehicle. In addition, the monitoring method and system may monitor various components of the power system, and are suitable not only for rotating components, but also for other structural components.

Although embodiments have been described illustratively in the above description, it should be understood that there are still a large number of embodiment variations through combinations of all known technical features and implementations as well as those that are readily apparent to those skilled in the art. In addition, it should be also understood that the exemplary implementations are just examples, and such embodiments shall not in any way limit the scope of protection, application, and construction of the present disclosure. The foregoing description is more intended to provide those skilled in the art with a technical guidance for converting at least one exemplary implementation, in which various changes, especially changes in the functions and structures of the components, can be made as long as they do not depart from the scope of protection of the claims.

### LIST OF REFERENCE NUMERALS

1 Cab
2 Chassis
3 Transmission
4 Axle
5 Hub
6 Sound sensor
7 Vibration sensor
8 Data processing subsystem
9 End user and/or control system

1. A fault monitoring method for monitoring an operating state of a power system of a motor vehicle, wherein the fault monitoring method comprises:
collecting in real time a sound signal in a cab of the motor vehicle and one or more vibration signals that correspond to one or more monitoring positions in the power system, respectively;
calculating a frequency response function between the sound signal and each vibration signal and obtaining a peak point frequency corresponding to a peak point of each frequency response function;
calculating a coherence feature function between each vibration signal and the sound signal and obtaining an amplitude corresponding to the peak point frequency of each frequency response function;
judging whether the amplitude corresponding to the peak point frequency of each frequency response function is greater than a predetermined threshold value; and
when the amplitudes corresponding to the peak point frequencies of one or more frequency response functions are each greater than the predetermined threshold value, determining that a fault occurs at the monitoring positions where the vibration signals corresponding to the one or more frequency response functions are collected.

2. The fault monitoring method according to claim 1, wherein calculating a frequency response function between the sound signal and each vibration signal comprises:
calculating a cross-power density spectrum of each vibration signal and the sound signal, an auto-power density spectrum of the sound signal, and an auto-power density spectrum of each vibration signal;
calculating the frequency response function between the sound signal and each vibration signal based on the cross-power density spectrum of each vibration signal and the sound signal, the auto-power density spectrum of the sound signal, and the auto-power density spectrum of each vibration signal; and
obtaining a frequency response function matrix based on the frequency response function between the sound signal and each vibration signal.

3. The fault monitoring method according to claim 1, wherein the one or more monitoring positions in the power system comprise one or more of the following: a transmission housing, housings of one or more axles, and/or hubs corresponding to the one or more axles.

4. The fault monitoring method according to claim 1, wherein a position where the sound signal is collected is located in a peripheral area of a head of a driver in the cab.

5. The fault monitoring method according to claim 1, wherein the predetermined threshold value is 0.5.

6. The fault monitoring method according to claim 1, wherein the one or more vibration signals are vibration acceleration signals.

7. The fault monitoring method according to claim 1, wherein the fault monitoring method also comprises: when it is determined that the fault occurs at at least one monitoring position, sending information about the at least one monitoring position where the fault occurs to at least one of an end user or a control system of the motor vehicle.

8. A fault monitoring system for monitoring an operating state of a power system of a motor vehicle, wherein the fault monitoring system comprises a signal collection subsystem and a data processing subsystem, wherein
the signal collection subsystem comprises:
a sound sensor arranged in a cab of the motor vehicle to collect in real time a sound signal in the cab; and
one or more vibration sensors arranged at one or more monitoring positions in the power system, respectively, to collect in real time corresponding one or more vibration signals; and
the data processing subsystem comprises:
a first calculation module configured to calculate a frequency response function between the sound signal and each vibration signal and obtain a peak point frequency corresponding to a peak point of each frequency response function;
a second calculation module configured to calculate a coherence feature function between each vibration signal and the sound signal and obtain an amplitude corresponding to the peak point frequency of each frequency response function;
a judgment module configured to judge whether the amplitude corresponding to the peak point frequency of each frequency response function is greater than a predetermined threshold value; and
a determining module configured to: when the amplitudes corresponding to the peak point frequencies of one or more frequency response functions are each greater than the predetermined threshold value, determine that a fault occurs at the monitoring positions where the vibration signals corresponding to the one or more frequency response functions are collected.

9. The fault monitoring system according to claim 8, wherein the first calculation module is further configured to:
calculate a cross-power density spectrum of each vibration signal and the sound signal, an auto-power density spectrum of the sound signal, and an auto-power density spectrum of each vibration signal;
calculate the frequency response function between the sound signal and each vibration signal based on the cross-power density spectrum of each vibration signal and the sound signal, the auto-power density spectrum of the sound signal, and the auto-power density spectrum of each vibration signal; and
obtain a frequency response function matrix based on the frequency response function between the sound signal and each vibration signal.

10. The fault monitoring system according to claim 8, wherein the one or more vibration sensors are arranged at one or more of the following monitoring positions, respectively: a transmission housing, housings of one or more axles, and/or hubs corresponding to the one or more axles.

11. The fault monitoring system according to claim 8, wherein the sound sensor is arranged in a peripheral area of a head of a driver in the cab.

12. The fault monitoring system according to claim 8, wherein the judgment module is configured to use 0.5 as the predetermined threshold value.

13. The fault monitoring system according to claim 8, wherein the one or more vibration sensors are configured to collect vibration acceleration signals.

14. The fault monitoring system according to claim 8, wherein the data processing subsystem also comprises an information sending module, and the information sending module is configured to: when it is determined that the fault occurs at at least one monitoring position, send information about the at least one monitoring position where the fault occurs to at least one of an end user or a control system of the motor vehicle.

15. The fault monitoring system according to claim 8, wherein the data processing subsystem comprises a vehicle controller in which the first and second calculation modules, the judgment module and the determining module are integrated.

16. A fault monitoring system, comprising:
a signal collection subsystem comprising a sound sensor arranged in a cab of a motor vehicle to collect in real time a sound signal in the cab, and one or more vibration sensors arranged at one or more monitoring positions in a power system of the motor vehicle, to collect in real time corresponding one or more vibration signals;
a vehicle controller communicatively coupled to the signal collection system and which is configured to:
receive the sound signal and the one or more vibration signals;
calculate a frequency response function between the sound signal and each vibration signal and obtain a peak point frequency corresponding to a peak point of each frequency response function;
calculate a coherence feature function between each vibration signal and the sound signal and obtain an amplitude corresponding to the peak point frequency of each frequency response function;
determine whether the amplitude corresponding to the peak point frequency of each frequency response function is greater than a predetermined threshold value; and
when the amplitudes corresponding to the peak point frequencies of one or more frequency response functions are each greater than the predetermined threshold value, determine that a fault occurs at the monitoring positions where the vibration signals corresponding to the one or more frequency response functions are collected.
